(19) United States
(12) Patent Application Publication
(10) Pub. No.: US 2009/0221188 A1
(43) Pub. Date: Sep. 3, 2009

(54) CONNECTOR AND PORT THEREOF

(75) Inventors: FEI GAO, Shenzhen City (CN); WEN-HAW TSENG, Tu-Cheng (TW); LI LI, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/351,856

(22) Filed: Jan. 12, 2009

(30) Foreign Application Priority Data
Feb. 29, 2008 (CN) 200810300438.6

(51) Int. Cl. H01R 24/00

(52) U.S. Cl. 439/676

(57) ABSTRACT

A connector includes a plug and a port. The port defines a notch and a groove in an inner surface of the port. The groove extends in the inner surface along a circumferential direction. The notch extends from an opening in the port and communicates with the groove. The plug forms a protrusion in an outer surface of the plug. The protrusion is capable of sliding along the notch and in the groove, and rotating along the groove in the circumferential direction to be received in the groove. A related port of the connector is also provided.

### BACKGROUND

1. Field of the Disclosure

The present disclosure relates to connectors, and more particularly to a connector that includes a plug and a port.

2. Description of Related Art

Most electrical connectors connects two electrical/electronic (hereinafter electrical) devices for data communication or power transfer between the two electrical devices. Most connectors include two parts, a “male” part and a “female” part or sometimes called a “plug” and a “port”. For example, an audio connector includes a port and a plug. The port is the part that is mechanically mounted on the audio player and is electrically coupled to an electric circuitry of the audio player. The plug is electrically connected to an earphone via a transmission line and is capable of being inserted in the port to establish an electrical connection between the plug and the port. Thus, data can be transmitted from the audio player to the earphone. However, some plugs may be easily disconnected or disengaged from the port and the user must reconnect the plug and port. This is an inconvenience.

Therefore, a heretofore unaddressed need exists in the industry to overcome the aforementioned deficiencies and inadequacies.

### BRIEF DESCRIPTION OF THE DRAWINGS

FIG. 1 is a perspective view of a connector comprising a plug and a port in accordance with a first embodiment of the disclosure.

FIG. 2 is a status view of the connector of FIG. 1 with the plug inserted in the port.

FIG. 3 is a status view of the connector of FIG. 1 with the plug screwed and locked in the port.

FIG. 4 is a perspective view of a connector in accordance with a second embodiment of the disclosure.

FIG. 5 is a perspective view of a connector in accordance with a third embodiment of the disclosure.

### DETAILED DESCRIPTION

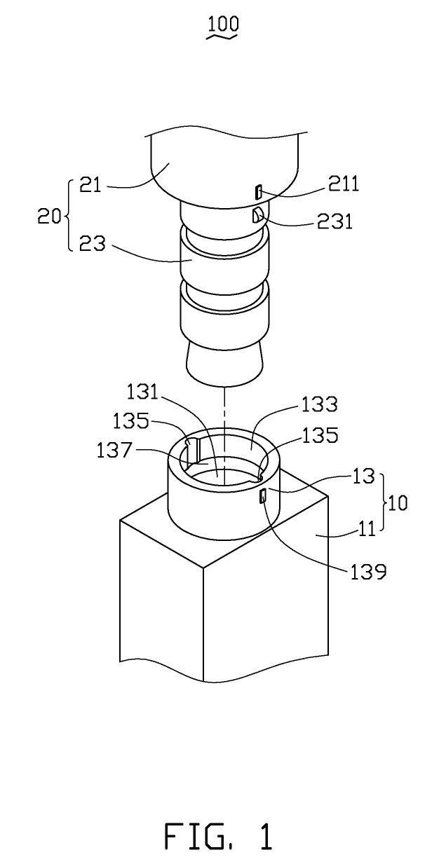

FIG. 1 is a perspective view of a connector 100 in accordance with a first embodiment of the disclosure. The connector 100 includes a port 10 and a plug 20. The plug 20 is inserted in the port 10 and rotated to be locked. The connector 100 further includes a securing mechanism for detachably fixing the plug to the port. The securing mechanism includes a locking portion and an engagement portion respectively defined on the plug 20 and the port 10.

The port 10 comprises a main body 11 and a receiving portion 13 that protrude from the main body 11. The receiving portion 13 defines a receiving hole 131 for detachably receiving the plug 20. The receiving hole 131 is cylindrical in shape. The receiving portion 13 defines the locking portion that includes two notches 135 and a groove 137 in an inner surface 133 of the receiving portion 13.

Each of the two notches 135 extends in parallel to an axial direction of the receiving portion 13 from an opening in the port 10 and communicates with the groove 137.

The groove 137 is defined in the inner surface 133 of the receiving portion 13 and extends along a circumferential direction of the receiving portion 13 that is perpendicular to the axial direction of the receiving portion 13. A length of the groove 137 may be a whole or a part of an inner circle of the receiving portion 13.

Two indicators 139 are defined on an outer surface of the receiving portion 13, for indicating the positions of the two notches 135 correspondingly. The indicators 139 are protrusions that protrude from the outer surface of the receiving portion 13.

The plug 20 includes a cylindrical holding portion 21 and a cylindrical joining portion 23 fixed to the holding portion 21. The joining portion 23 is configured to be inserted in the receiving hole 131 and be electrically coupled to the port 10. The engagement portion is formed on the plug 20, for engaging with the notch 135. The engagement portion is a protrusion 231 that protrudes from an outer surface of the joining portion 23. The dimensions of the protrusion 231 are equal to that of the notch 135.

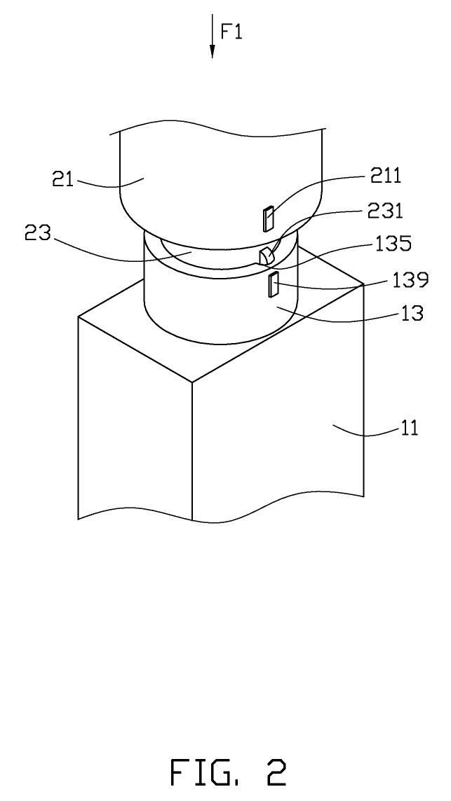

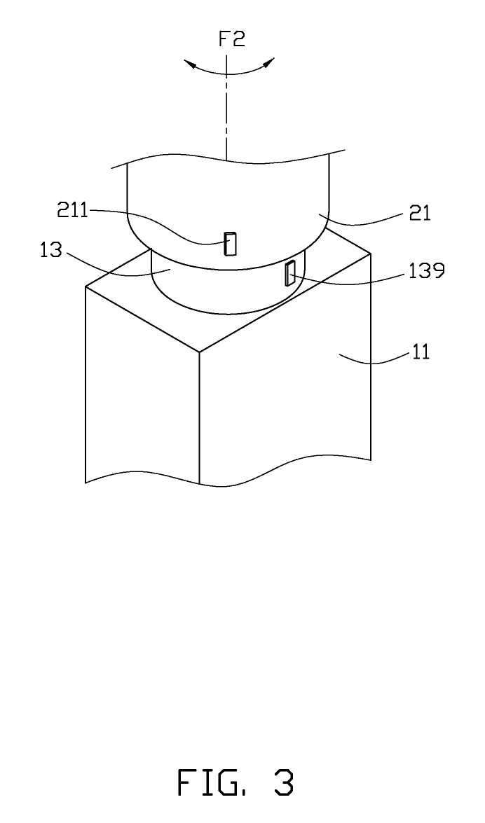

In use, referring to FIGS. 2 and 3, the joining portion 23 is inserted in the receiving hole 131, with the protrusion 231 sliding along the notch 135 and in the groove 137. After the protrusion 231 reaches the groove 137, the protrusion 231 is rotated along with the plug 20 to be received in the groove 137. Accordingly, the plug 20 is firmly fixed to the port 10, and is prevented from inadvertently being disengaged from the port 10.

An indicator 211 is defined on the holding portion 21, for indicating the position of the protrusion 231 when the plug 20 is inserted in the port 10. The indicator 211 is a protrusion that protrudes from the outer surface of the holding portion 21.

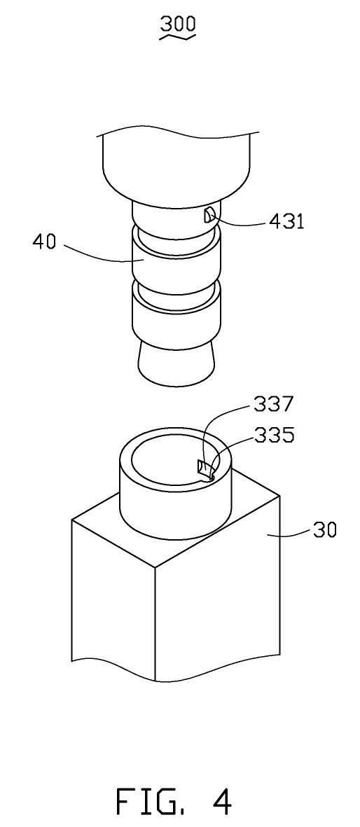

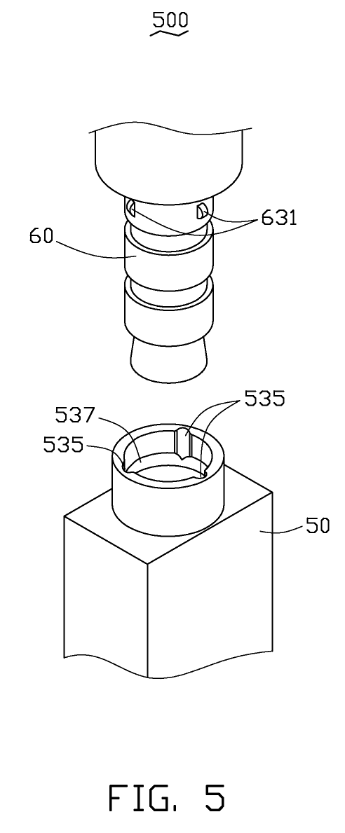

Referring to FIGS. 4 and 5, the number of notches 135 and protrusions 231 may vary with the requirements of the designers, as such, some connectors may have one, two, or three notches, the number of notches 135 is equal to the number of protrusions 231. The number of indicators 139 is equal to the number of notches 135, and the number of the indicators 211 is equal to the number of protrusions 231.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector comprising:
a port defining at least one notch and a groove in an inner surface of the port, the groove extending in the inner surface along a circumferential direction, and the notch extending from an opening in the port and communicating with the groove; and
a plug forming at least one protrusion on an outer surface of the plug, the protrusion capable of sliding along the notch and in the groove, and rotating along the groove in the circumferential direction to be received in the groove.

2. The connector as claimed in claim 1, wherein the number of the notch is equal to that of the protrusion.

3. The connector as claimed in claim 1, wherein at least one indicator is defined on an outer surface of the port for indicating the position of the notch.

4. The connector as claimed in claim 3, wherein the number of the indicator is equal to that of the notch.

5. The connector as claimed in claim 1, wherein at least one indicator is defined on the plug for indicating the position of the protrusion when the plug is inserted in the port.

6. The connector as claimed in claim 5, wherein the number of the indicator is equal to that of the protrusion.

7. The connector as claimed in claim 1, wherein a length of the groove is a whole or a part of an inner circle of the port.

8. The connector as claimed in claim 1, wherein the notch is perpendicular to the groove.

9. A port comprising at least one notch and a groove defined in an inner surface of the port, the groove extending in the inner surface along a circumferential direction, and the at least one notch extending from an opening in the port and communicating with the groove.

10. The port as claimed in claim 9, wherein at least one indicator is defined on an outer surface of the port for indicating the position of the notch.

11. The port as claimed in claim 10, wherein the number of the indicator is equal to that of the notch.

12. The port as claimed in claim 9, wherein a length of the groove is a whole or a part of an inner circle of the port.

13. The port as claimed in claim 9, wherein the notch is perpendicular to the groove.

14. A connector comprising a port, a plug and a securing mechanism for detachably fixing the plug to the port; the securing mechanism comprising a locking portion and an engagement portion respectively defined on the plug and the port.

15. The connector as claimed in claim 14, wherein the locking portion comprises a groove extending in an inner surface of the port along a circumferential direction, and at least one notch extending from an opening in the port and communicating with the groove.

16. The connector as claimed in claim 14, wherein the engagement portion is a protrusion formed on an outer surface of the plug, the protrusion capable of sliding along the notch and in the groove, and rotating along the groove in the circumferential direction to be received in the groove.

17. The connector as claimed in claim 15, wherein the notch is perpendicular to the groove.
